(19) United States
(12) Patent Application Publication
(10) Pub. No.: US 2012/0212605 A1
(43) Pub. Date: Aug. 23, 2012

(54) DEFECT INSPECTION APPARATUS AND DEFECT INSPECTION METHOD

(76) Inventors: Go Maruyama, Kanagawa (JP); Masahiro Fujimoto, Kanagawa (JP); Sadao Takahashi, Kanagawa (JP); Jun Watanabe, Kanagawa (JP); Toshimichi Hagiya, Tokyo (JP); Shin Aoki, Kanagawa (JP); Issei Abe, Kanagawa (JP); Shigeru Ouchida, Tokyo (JP)

(21) Appl. No.: 13/372,868

(22) Filed: Feb. 14, 2012

(30) Foreign Application Priority Data
Feb. 17, 2011 (JP) 2011-032219
Nov. 2, 2011 (JP) 2011-240980

(51) Int. Cl. H04N 7/18

(52) U.S. Cl. 348/125; 348/E07.085

(57) ABSTRACT

A defect inspection apparatus includes an imaging apparatus configured to include a lens array configure to include plural lenses arranged in a form of an array, and an imaging device configured to image a compound-eye image that is a collection of ommatidium images of an object approximately formed by the respective plural lenses of the lens array; and a processing apparatus configured to process the compound-eye image obtained from imaging the object by the imaging apparatus, and determine whether there is a defect of the object.

### BACKGROUND OF THE INVENTION

1. Field of the Invention

The present invention relates to a defect inspection apparatus and a defect inspection method for inspecting a to-be-inspected object to determine whether a surface of the to-be-inspected object has a defect such as a flaw, a deformation, a dent or the like.

2. Description of the Related Art

An inspection method of illuminating a to-be-inspected object such as a workpiece, photographing the to-be-inspected object using reflected light therefrom, carrying out image processing on the photographed image, and determining whether a defect exists on a surface of the to-be-inspected object, is known. Further, it is also known to photograph a to-be-inspected object using plural cameras from plural positions, or photograph a to-be-inspected object using plural light and switching a positron of illuminating the to-be-inspected object while keeping the to-be-inspected object and the photographing position unchanged, for the purpose of improving defect determination accuracy (for example, see Japanese Laid-Open Patent Application No. 8-75661 and Japanese Laid-Open Patent Application No. 2008-249568).

By photographing a to-be-inspected object by plural cameras from plural positions, relative positional relationship between the to-be-inspected object and the photographing position changes. Therefore, photographed images differ. Then, by carrying out image processing for defect determination on the thus obtained plural photographed images, it is possible to improve defect determination accuracy. Further, the same advantageous effect is also expected when using plural light sources and switching a position of illuminating a to-be-inspected object while keeping the to-be-inspected object and a photographing position unchanged.

### SUMMARY OF THE INVENTION

According to one aspect of the present invention, an imaging apparatus is provided including a lens array in which plural lenses are arranged in a form of an array and an imaging device configured to image a compound-eye image that is a collection of size-reduced images (ommatidium images) of an object, which images are approximately formed by the respective plural lenses of the lens array. Further, a processing apparatus is provided which is configured to process the compound-eye image obtained from photographing the object by the imaging apparatus, and determine whether the object has a defect.

Other objects, features and advantages of the present invention will become more apparent from the following detailed description when read in conjunction with the accompanying drawings.

### BRIEF DESCRIPTION OF THE DRAWINGS

FIG. 1 shows a general configuration diagram of one embodiment of a defect inspection apparatus according to the present invention;

FIG. 2 schematically shows an imaging apparatus shown in FIG. 1 from a direction of an object;

FIGS. 3A, 3B, 3C and 3D illustrate a concept of distortion correction;

FIG. 4 illustrates a method of calculating a difference amount (parallax) of an imaging position between ommatidium images;

FIG. 5 is one example of a parallax table of a parallax data storage part shown in FIG. 1;

FIG. 6 is a detailed block diagram showing a defect determination part shown in FIG. 1;

FIG. 7 is a processing flowchart of an ommatidium image defect determination part shown in FIG. 6;

FIGS. 8A, 8B and 8C show specific examples of determination results in the ommatidium image defect determination part;

FIG. 9 is a processing flowchart of an integrated determination part shown in FIG. 6;

FIG. 10 is a detailed flowchart of parallax considering determination shown in FIG. 9;

FIG. 11 is another processing flowchart of the ommatidium image defect determination part shown in FIG. 6;

FIG. 12 is a graph showing a relationship between an image height and a correction coefficient for an evaluation value;

FIGS. 13A, 13B and 13C show other specific examples of determination results in the ommatidium image defect determination part;

FIG. 14 is another processing flowchart of the integrated determination part shown in FIG. 6;

FIG. 15 is a detailed flowchart of parallax considering determination shown in FIG. 14;

FIG. 16 shows one example of photographing an object using two cameras in the related art; and

FIG. 17 shows one example in which degrees of out-of-focus are different in a case where optical axes of two cameras are not parallel.

### DETAILED DESCRIPTION OF THE EMBODIMENTS

As mentioned above, carrying out defect inspection of a to-be-inspected object using plural cameras is advantageous. However, in this method, a problem may occur as described below. It is noted that it is assumed that two cameras (stereoscopic camera) are used.

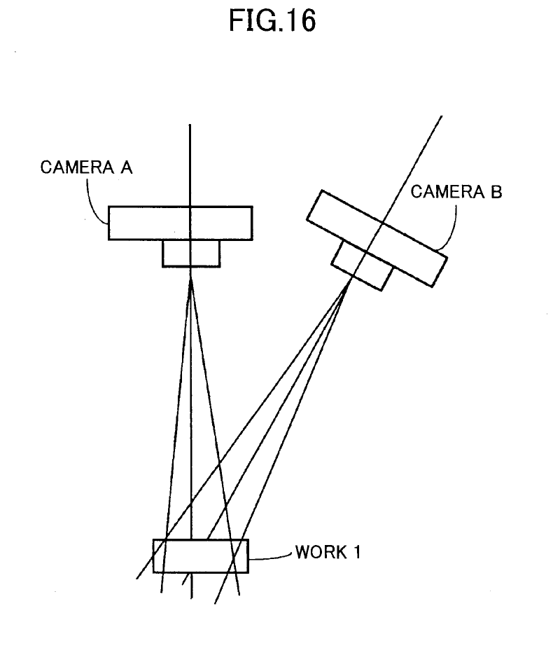

As a defect (a flaw, a chip, a flash or the like), there is not only one having a large size but also one that cannot be determined by human eyes such as one of micrometers through millimeters, or the like. On the other hand, generally speaking, a stereoscopic camera has a large size of the camera alone, for example, centimeters or more. Therefore, when the stereoscopic camera is used for inspecting for a defect on the order of millimeters or less, it is necessary to provide a photographing condition in which the two cameras included in the stereoscopic camera are arranged in inclined states; or the two cameras are set in parallel, and a distance to a to-be-inspected object is increased so that photographing is carried out in a state like a telephotographic camera. However, when the distance to the to-be-inspected object is thus increased, it may be impossible to satisfy the customer's request of photographing a small defect in a closeup state. Therefore, the above-mentioned method using the photographing condition in which the two cameras are arranged in an inclined state may be rather used. In this case, as shown in FIG. 16, the optical axes of the two cameras A and B are not parallel to each other.

In a case where defect inspection is carried out using images taken using these two cameras A and B having the optical axes not parallel to each other (images of non-parallel axes), it is necessary to correct the taken images into those of parallel optical axes (images of parallel axes). Therefore, a buffer or the like for temporarily storing the images of non-parallel axes, a time required for carrying out processing to correct the images of non-parallel axes into the images of parallel axes, and so forth, are needed. However, in particular, a tact time is the most important problem in defect inspection. Therefore, the time required for carrying out processing to correct the images of non-parallel axes into the images of parallel axes may be a very serious problem.

Furthermore, generally speaking, as characteristics of a lens, a depth of field is narrow for a short distance area. Therefore, in the case where the optical axes are not parallel to each other, degrees of out-of-focus in respective images taken by the right and left cameras are very different from each other. If defect inspection is carried out using the images having different degrees of out-of-focus, accuracy may be degraded accordingly.

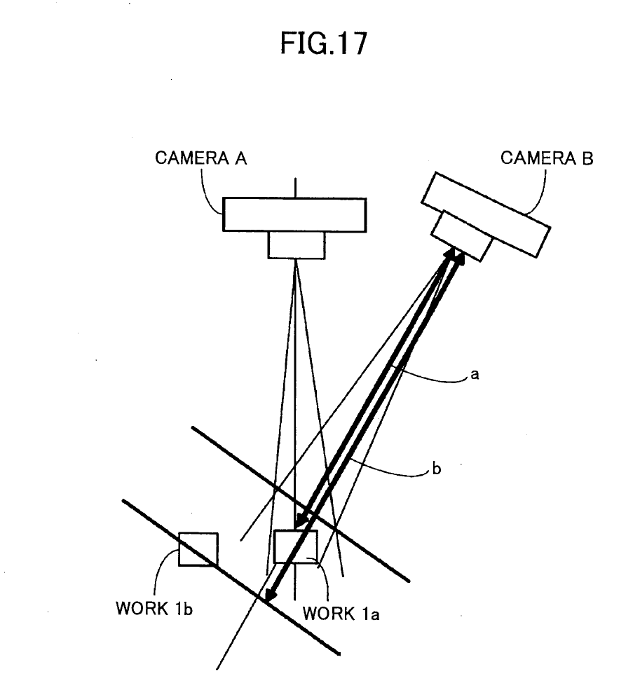

Using FIG. 17, an example will now be described in which degrees of out-of-focus in images taken by two cameras are different in a case where optical axes of the two cameras are not parallel to each other. FIG. 17 shows a state where as to-be-inspected objects, a workpiece 1a and a workpiece 1b are drawn, and a difference exists in a photographing condition between the cameras A and B in defect inspection. At this time, the distances of the workpieces 1a and 1b from a camera A are the same as each other, but the distances of the workpieces 1a and 1b from a camera B are different from each other. In FIG. 17, “a” denotes the distance of the workpiece 1a from the camera B and “b” denotes the distance of the workpiece 1b from the camera B. By the difference between the distances “a” and “b”, the degrees of out-of-focus in the images of the workpieces 1a and 1b photographed by the camera B vastly differ from each other, which may seriously influence the accuracy of defect inspection.

Embodiments of the present invention have been devised in consideration of the above-mentioned problem, and an object of the embodiments is to provide a defect inspection apparatus and a defect inspection method by which it is possible to carry out defect inspection of a to-be-inspected object in a miniaturized apparatus configuration with high accuracy, in comparison to a stereoscopic camera or the like.

More specifically, an object of the embodiments of the present invention is to provide a defect inspection apparatus and a defect inspection method most suitable for inspection for a flaw, a flash or the like on the order of millimeters or less.

According to the embodiments of the present invention, an imaging apparatus is provided including a lens array in which plural lenses are arranged in a form of an array, and an imaging device configured to image a compound-eye image that is a collection of size-reduced images (ommatidium images) of an object, which images are approximately formed by the respective plural lenses of the lens array. Further, a processing apparatus is provided which is configured to process the compound-eye image obtained from photographing the object by the imaging apparatus, and determine whether the object has a defect.

More specifically, the processing apparatus has an image capture part configured to separate the compound-eye image obtained from the imaging apparatus into plural ommatidium images; and a defect determination part configured to determine whether there is a defect of the object based on the plural ommatidium images. The processing apparatus may preferably further have an image correction part configured to carry out distortion correction of the respective separated plural ommatidium images.

The defect determination part is configured to include an ommatidium image defect determination part configured to determine whether there is a defect for the respective plural ommatidium images and an integrated determination part configured to determine whether there is a defect of the object based on the respective defect determination results for the plural ommatidium images obtained from the ommatidium image defect determination part. The ommatidium image defect determination part is configured to determine, for each of the plural ommatidium images, one of “defect exists”, “no defect” and “indeterminable”. The integrated determination part is configured to determine “no defect” for the object, when the defect determination results for all the ommatidium images are “no defect”. The integrated determination part is configured to determine “defect exists” for the object, when the defect determination result for at least one of the ommatidium images is “defect exists”. In the other cases, the integrated determination part is configured to determine “indeterminable” for the object, based on the ommatidium images.

According to a first embodiment of the present invention, described later in details using figures, the ommatidium image defect determination part is configured to obtain, for each of the plural ommatidium images, a difference value between the ommatidium image and a normal ommatidium image for each pixel or each small area as an evaluation value. Then, in a case where each of the evaluation values of all the pixels or small areas is equal to or less than a first threshold, the ommatidium image defect determination part is configured to determine “no defect” for the ommatidium image. In a case where at least one of the evaluation values of the pixels or small areas is equal to or greater than a second threshold (the first threshold<the second threshold), the ommatidium image defect determination part is configured to determine “defect exists” for the ommatidium image. In the other cases, the ommatidium image defect determination part is configured to determine “indeterminable” for the ommatidium image. Then, in a case where all the ommatidium images thus has “no defect”, the integrated determination part is configured to determine “no defect” for the object. In a case where at least one of the ommatidium images has “defect exists”, the integrated determination part is configured to determine “defect exists” for the object. In the other cases, based on the ommatidium images having “indeterminable”, the integrated determination part is configured to determine “no defect” for the object in a case where the number of the ommatidium images having “indeterminable” is one. On the other hand, in a case where the number of the ommatidium images having “indeterminable” is two or more, the integrated determination part is configured to determine “defect exists” for the object in a case where pixels or small areas having the evaluation values greater than the first threshold and less than the second threshold exist at the same positions between the respective “indeterminable” ommatidium images after parallax correction is carried out on the respective “indeterminable” ommatidium images.

The integrated determination part is configured to determine “no defect” for the object in a case where pixels or small areas having the evaluation values greater than the first threshold and less than the second threshold do not exist at the same positions between the respective “indeterminable” ommatidium images after parallax correction is carried out on the respective “indeterminable” ommatidium images.

According to a second embodiment of the present invention, described later in details using figures, the ommatidium image defect determination part is configured to obtain, for each of the plural ommatidium images, a difference value between the ommatidium image and a normal ommatidium image for each pixel or each small area; obtain an evaluation value by correcting the difference value, according to an image height of the pixel or the small area; and classifying the thus obtained evaluation values into a defect degree of any one of predetermined plural levels. Then, in a case where each of the defect degrees of all the pixels or small areas has the minimum one of the predetermined plural levels, the ommatidium image defect determination part is configured to determine “no defect” for the ommatidium image. In a case where at least one of the defect degrees has the maximum one of the predetermined plural levels, the ommatidium image defect determination part is configured to determine “defect exists” for the ommatidium image. In the other cases, the ommatidium image defect determination part is configured to determine “indeterminable” for the ommatidium image.

Then, in a case where all the ommatidium images have “no defect”, the integrated determination part is configured to determine “no defect” for the object. In a case where at least one of the ommatidium images has “defect exists”, the integrated determination part is configured to determine “defect exists” for the object. In the other cases, based on the ommatidium images having “indeterminable”, the integrated determination part is configured to determine “no defect” for the object in a case where the number of the ommatidium images having “indeterminable” is one. In a case where the number of the ommatidium images having “indeterminable” is two or more, and in a case where pixels or small areas having the defect degrees greater than the minimum one and less than the maximum one of the predetermined plural levels exist at the same positions between the respective “indeterminable” ommatidium images on which parallax correction has been carried out, the corresponding defect degrees are added together. Then, in a case where the addition result is equal to or grater than the maximum one of the predetermined plural levels, the integrated determination part is configured to determine “defect exists” for the object. On the other hand, in a case where pixels or small areas having the defect degrees greater than the minimum one and less than the maximum one of the predetermined plural levels do not exist at the same positions between the respective “indeterminable” ommatidium images on which parallax correction has been carried out, the integrated determination part is configured to determine “no defect” for the object. Further, even when pixels or small areas having the defect degrees greater than the minimum one and less than the maximum one of the predetermined plural levels exist at the same positions between the respective “indeterminable” ommatidium images on which parallax correction has been carried out, the integrated determination part is configured to determine “no defect” for the object in a case where the addition result of the corresponding defect degrees is less than the maximum one of the predetermined plural levels.

According to the embodiments of the present invention, by using the imaging part having the lens array in which the plural lenses are arranged, it is possible to carry out defect inspection of the to-be-inspected object in a miniaturized configuration with high accuracy, in comparison to a stereoscopic camera or the like. Specifically, it is possible to obtain images, equal to those photographed using plural imaging parts, using the single imaging part.

Further, by carrying out defect determinations separately for the respective plural ommatidium images, and carrying out defect determination of the to-be-inspected object by combining the determination results of the separately carried out defect determinations for the respective plural ommatidium images, it is possible to carry out determination as to whether there is a defect of the to-be-inspected object with higher accuracy.

Below, the embodiments of the present invention will now be described using figures.

### First Embodiment

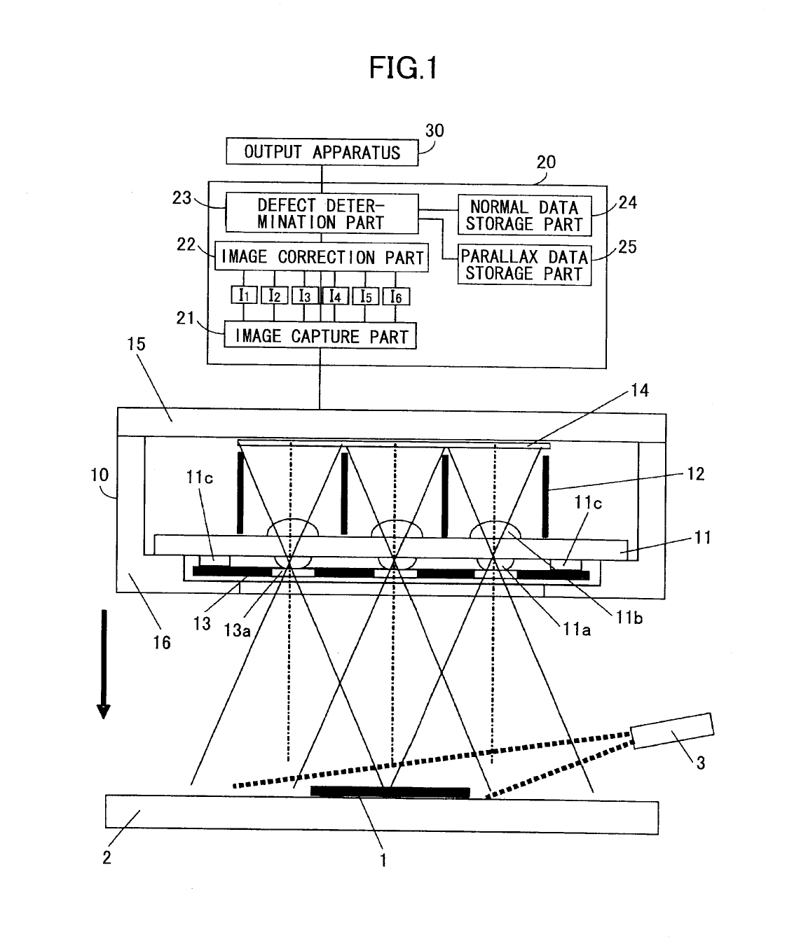

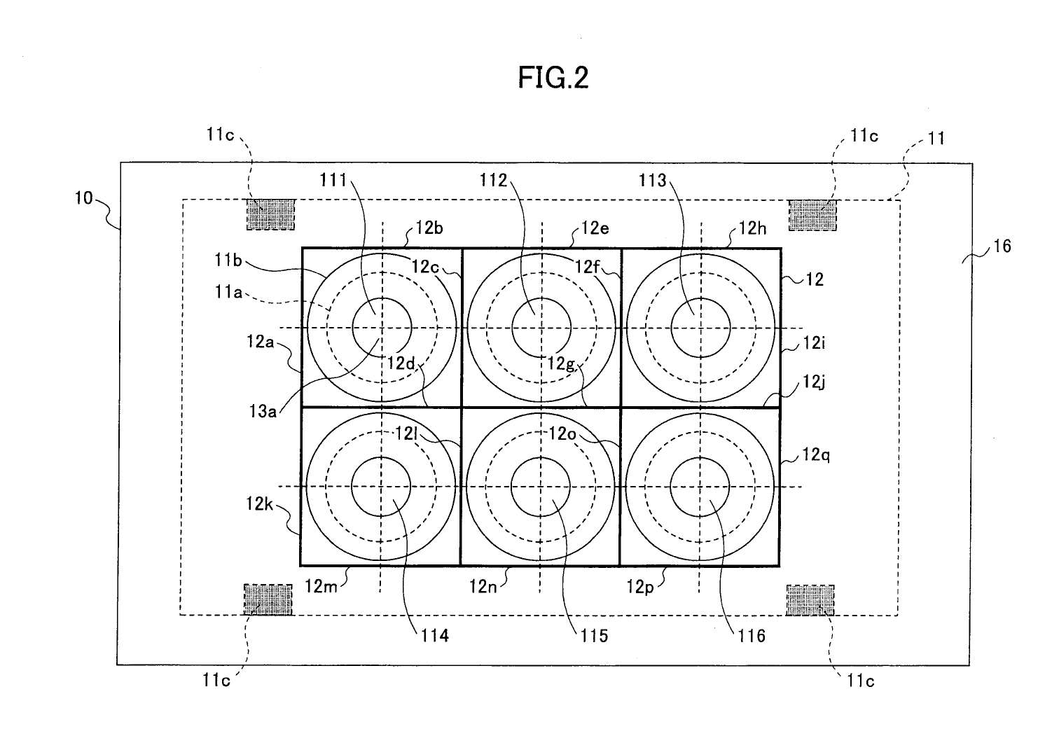

FIGS. 1 and 2 show a general configuration diagram of a defect inspection apparatus according to the first embodiment of the present invention. In FIG. 1, assuming that a to-be-inspected object exists in a direction of an arrow, a sectional schematic view of an imaging apparatus that images the to-be-inspected object and a general block diagram of a processing apparatus that carries out determination processing to determine whether there is a defect of the to-be-inspected object using an image imaged by the imaging apparatus, are shown. FIG. 2 is a plan schematic view of the imaging apparatus of FIG. 1 viewed from the direction of the to-be-inspected object. In FIG. 2, the common reference numerals are given to parts that are the same as those of FIG. 1. In FIGS. 1 and 2, “10” denotes the imaging apparatus, “20” denotes the processing apparatus, “30” denotes an output apparatus, “1” denotes the to-be-inspected object (workpiece) which is a target of the defect inspection, “2” denotes a placement table on which the to-be-inspected object 1 is placed, and “3” denotes an illuminant (light source) for illuminating the to-be-inspected object 1. As a result of the illuminant 3 illuminating the to-be-inspected object 1, it is possible to further highlight a position of a flaw, a deformation, a dent, or the like, if any, on a surface of the to-be-inspected object.

First, the imaging apparatus 10 will now be described. The imaging apparatus 10 includes a lens array 11, a light blocking wall 12, an aperture array 13, an imaging device 14, a substrate 15 and a housing 16.

The lens array 11 includes two sides, i.e., a side on an object side and a side on an image side. In the two sides, plural lenses are provided, and thus, the lens array 11 is a double side lens array. As shown in FIG. 1, the lenses 11a are provided on the object side and the lenses 11b are provided on the image side. The lenses 11a and the lenses 11b are combined to form the respective sets (hereinafter, referred to as “lens sets”), and the respective lens sets form images on an image surface. According to the first embodiment, as shown in FIG. 2, the lens array 11 includes the 6 lens sets 111, 112, 113, 114, 115 and 116. The respective lens sets are arranged at equal intervals, the optical axes are parallel to each other and the focal lengths are equal to each other.

The light blocking wall 12 is provided between the image side of the lens array 11 and the imaging device 14. The light blocking wall 12 provides light blocking partitions that prevent crosstalk of light beams between the adjacent lens sets of the lens array 11, and are made of material such as metal, resin or the like, which is opaque with respect to the imaging light. As shown in FIG. 2, in the light blocking wall 12, rectangular holes are formed corresponding to the respective lens sets 111 through 116 of the lens array 11, and walls of the light blocking wall 12 provided between the holes act as the partitions preventing crosstalk. One end of the light blocking wall 12 is fixed to the image side of the lens array 11. It is noted that according to the first embodiment, the light blocking wall 12 is cut into respective sides (12a through 12q in FIG. 2) for the purpose that the light blocking wall 12 can move as the lens array 11 thermally expands.

On the other hand, on the object side of the lens array 11, the aperture array 13 is provided. The aperture array 13 has a structure in which circular holes (apertures) are provided corresponding to the respective lens sets 111 through 116 in a plate-shaped member, and provides aperture stops for the lenses. The aperture array 14 is fixed to the lens array 11 via respective projections 11c provided at four corners of a flat surface part of the side of the lens array 11 on the object side.

The imaging device 14 is made of, for example, a CMOS sensor. The imaging device 14 receives light having passed through the respective lens sets 111 through 116 of the lens array 11, converts respective optical images of the to-be-inspected object (workpiece) 1 into electrical signals of image data, and outputs the electrical signals of image data. The imaging device 14 is mounted on the substrate 15. On the substrate 15, also a controller that controls the imaging device is mounted. However, the controller is omitted in FIG. 1. It is noted that a part or all of the functions of the processing apparatus 20 described later may also be mounted on the substrate 15.

A peripheral part of the side of the lens array 11 on the object side is fixed to the housing 16, and the housing 16 holds the lens array 11, the light blocking wall 12 and the aperture array 13 to unify them. The substrate 15 is fixed to the housing 16 in such a manner that the light receiving surface of the imaging device 14 on the substrate 15 faces the lens array 11. In FIG. 1, although an optical lowpass filter for preventing aliasing and a cover glass for protecting the sensor are not particularly provided, they may be provided if necessary.

Thus, the configuration example of the imaging apparatus 10 has been described. However, the lens array 11 may have a structure in which plural single lenses are arranged, and also, the number of the lens sets or lenses may be other than 6. Further, plural lens arrays may be provided in a manner of superposing them together so that the imaging apparatus having higher optical performance may be provided.

Next, the processing apparatus 20 will be described. As shown in FIG. 1, the processing apparatus 20 includes an image capture part 21, an image correction part 22, a defect determination part 23, a normal data storage part 24 and a parallax data storage part 25. A CPU (not shown) acts as the image capture part 21, the image correction part 22 and the defect determination part 23, and a nonvolatile memory (ROM or the like) (not shown) acts as the normal data storage part 24 and the parallax data storage part 25. The processing apparatus 20 also includes a memory (RAM or the like) (not shown) for holding image data that is being processed.

As the imaging apparatus 10 photographs the to-be-inspected object 1, image data of a compound-eye image (that is a collection of six optical images (ommatidium images) of the to-be-inspected object 1 formed through the respective lens sets 111 through 116 of the lens array 11) is obtained in the imaging device 14. The image capture part 21 inputs the compound-eye image data from the imaging device 14 and captures the compound-eye image data, and separates the compound-eye image data into six sets of ommatidium image data (hereinafter, simply referred to as ommatidium images) I₁ through I₆. The ommatidium images I₁ through I₆ correspond to the six optical images of the to-be-inspected object formed through the lens sets 111 through 116 of the lens array 11, respectively. Since peripheries of the respective ommatidium images obtained in the imaging device 14 are blackened because of the light blocking wall 12, the respective ommatidium images I₁ through I₆ can be easily separated using the blackened peripheries as boundaries therebetween.

The image correction part 22 carries out distortion correction, using previously calculated distortion correction processing parameters such as internal parameters unique to the camera concerning working accuracy and assembly accuracy of the lenses, on the respective ommatidium images separated by the image capture part 22. For example, Zhang's method (“A flexible new technique for camera calibration”. IEEE Transactions on Pattern Analysis and Machine Intelligence, 22(11): 1330-1334, 2000) may be used for the distortion correction.

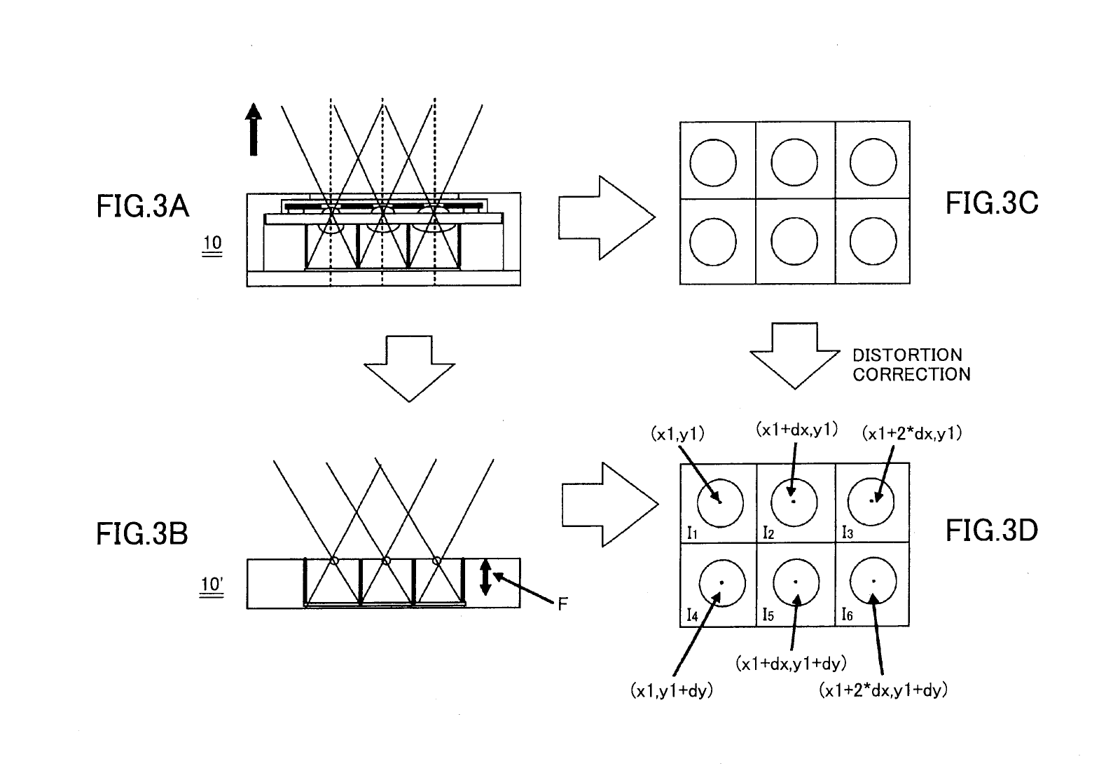

FIGS. 3A, 3B, 3C and 3D show a concept of the distortion correction. FIG. 3A shows the imaging apparatus 10 shown in FIGS. 1 and 2. FIG. 3C shows images having distortion photographed by the imaging apparatus 10. FIG. 3D shows images without distortion, on which images the distortion correction has been carried out. Carrying out the distortion correction on a photographed image means converting the photographed image into an image which is like an image obtained using a pinhole camera, i.e., an image for which an imaging position is F*tan (θ) when an incident angle from an object is θ and a focal length is F. In other words, the image of FIG. 3D obtained from carrying out the distortion correction on the image of FIG. 3C photographed by the imaging apparatus of FIGS. 1 and 2 can be considered as an image photographed using pinhole cameras, assuming an imaging apparatus (virtual imaging apparatus) including an array of the six pinhole cameras instead of the imaging apparatus 10. FIGS. 3B and 3D show this situation.

The defect determination part 23 inputs the ommatidium images I₁ through I₆, on which the distortion correction has been carried out by the image correction part 22, and determines whether there is a defect of the to-be-inspected object (workpiece) 1. Hereinafter, it is assumed that the ommatidium images I₁ through I₆ (on which the distortion correction has been carried out) are those photographed using the above-mentioned virtual imaging apparatus 10′ including the array of the pinhole cameras instead of the actual imaging apparatus 10, as shown in FIGS. 3B and 3D.

Here, for the sake of simplifying the description, it is assumed that the six pinhole cameras of the virtual imaging apparatus 10′ have the same focal length F, the corresponding six optical axes are parallel to each other and the centers of the corresponding images can be expressed by the coordinates (x₁, y₁), (x₁+dx, y₁), (x₁+2dx, y₁), (x₁, y1+dy) , (x₁+dx, y₁+dy), (x₁+2dx, y₁+dy), respectively (see FIG. 3D).

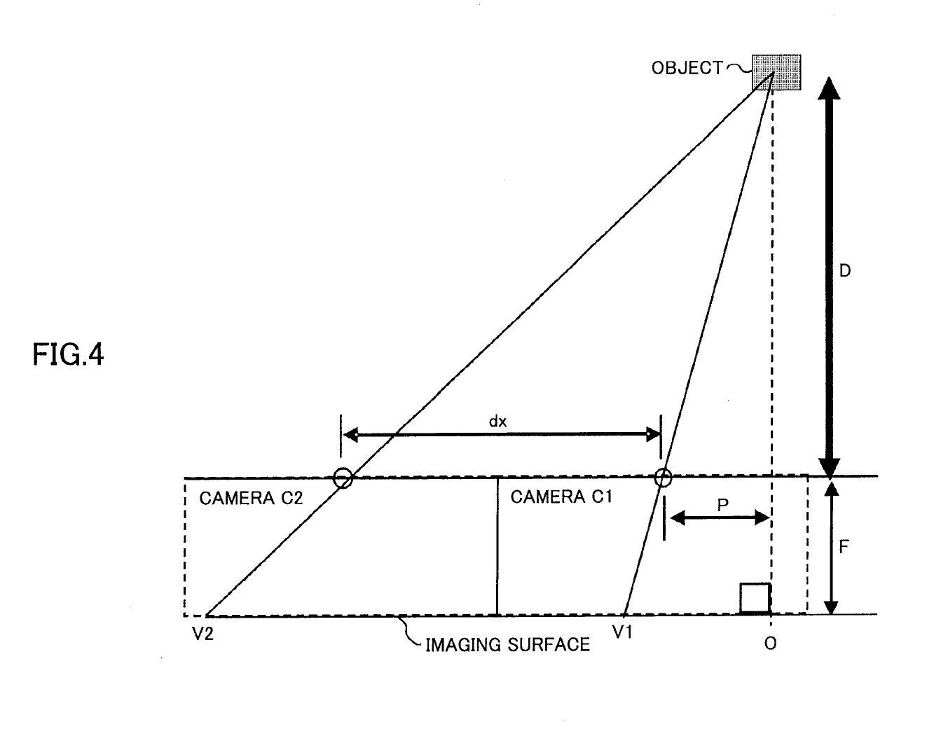

Before describing the defect determination part 23, difference amounts (parallax) between the ommatidium images will now be described. A difference amount in an imaging position of an object when the object at a position of a distance D from the virtual imaging apparatus is photographed can be calculated, as follows, according to FIG. 4. In FIG. 4, it is assumed that cameras C1 and C2 are pinhole cameras having focal lengths of F, and respective imaging surfaces are on the same plane. Further, imaging positions of the cameras C1 and C2 are V1 and V2, respectively, when a distance between the focuses (distance between centers of images) is dx and the object at the position of the distance D from the focuses is photographed. At this time, assuming that the distance between the focus position of the camera C1 and the intersection of the line perpendicularly extending from the object to the imaging surface and the imaging surface is P, the following formulas hold:

OV1=(F+D)*P/D

OV2=(F+D)*(P+dx)/D

Therefore, the difference amount (parallax) of the imaging positions when the object of the distance D is photographed by the cameras C1 and C2 is obtained by the following formula:

OV2−OV1=F/D*dx+dx

Therefore, a difference amount of a pixel in ommatidium areas when the object is photographed using the cameras C1 and C2 is F/D*dx.

Therefore, as shown in FIG. 3D, it can be seen that in a case where the center of image of the ommatidium image I₁ is (x₁, y₁) and the center of image of the ommatidium image 1₂ is (xₗ+dx, ₁⁷₁), the object at the position of the distance D from the imaging apparatus is imaged at positions different by (F/D*dx, 0) between the ommatidium image I₁ and the ommatidium image I₂. Further, in a case where the center of image of the ommatidium image I₁ is (x₁, y₁) and the center of image of the ommatidium image I₅ is (x₁+dx, y₁+dy), the object at the position of the distance D from the imaging apparatus is imaged at positions different by (F/D*dx, F/D*dy) between the ommatidium image I₁ and the ommatidium image I₅. That is, when the planate to-be-inspected object 1 is placed on the placement table 2 having the plane shape at the position of the distance D from the imaging apparatus 10, the difference amounts (parallax) such as those shown on the first line of

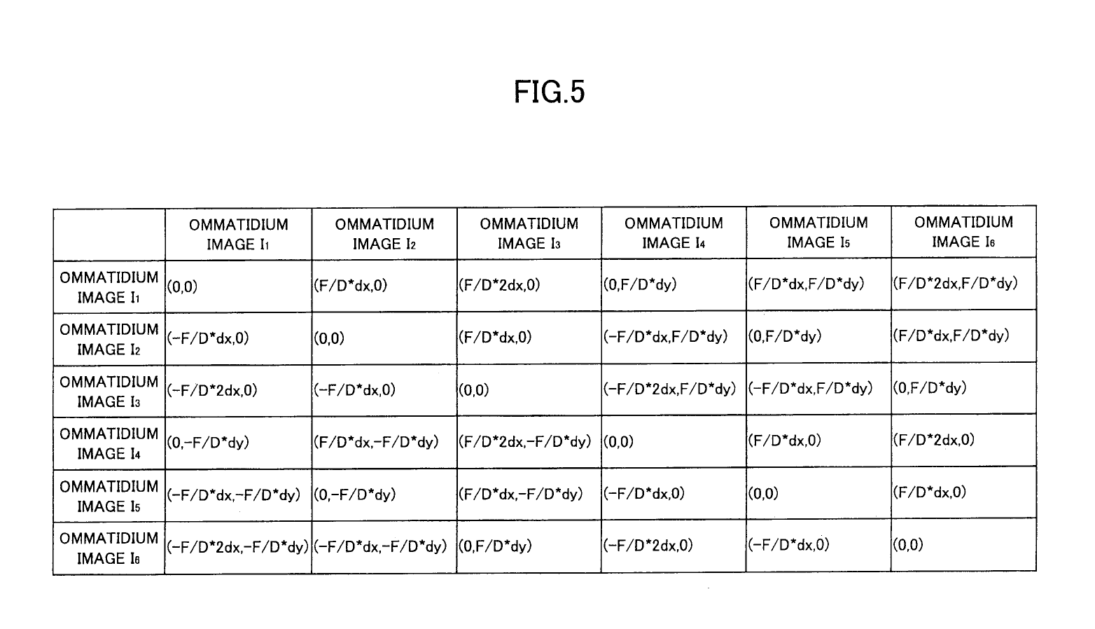

FIG. 5 are obtained in the respective ommatidium images I₁ through I₆ when the ommatidium image I₁ is used as a reference (assuming that the ommatidium images have no distortion, and the thickness of the workpiece can be ignored). Similarly, the difference amounts (parallax) such as those shown on the second through sixth lines of FIG. 5 are obtained in the respective ommatidium images I₁ through I₆ when the ommatidium image I₂ through I₆ are used as references, respectively.

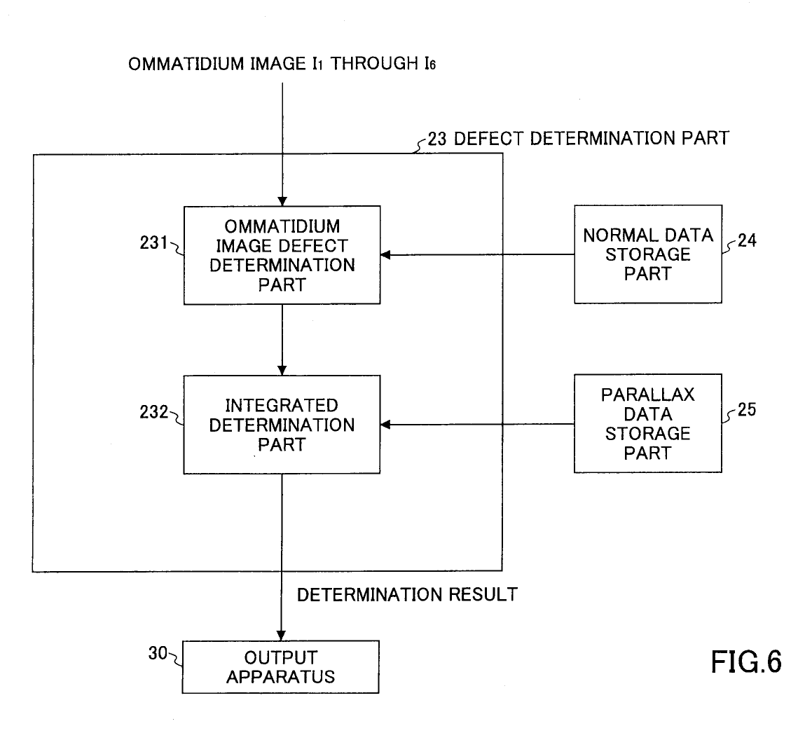

Below, the defect determination part 23 will be described in detail. FIG. 6 is a block diagram showing a configuration example of the defect determination part 23. The defect determination part 23 includes an ommatidium image defect determination part 231 and an integrated determination part 232. The ommatidium defect determination part 231 compares the 6 ommatidium images I_{I} through I₆ on which distortion correction has been carried out by the image correction part 22 with normal ommatidium images I₀₁ through I₀₆, respectively, and determines “defect exists”, “no defect” or “indeterminable” for each of the 6 ommatidium images I₁ through I₆. It is noted that previously, a normal object (normal workpiece) is photographed by the imaging apparatus 10, then distortion correction is carried out on the thus obtained 6 ommatidium images, respectively, and the thus corrected respective ommatidium images are stored as the normal ommatidium images I₀₁ through I₀₆ in the normal data storage part 24. Based on the respective determination results for the 6 ommatidium images I₁ through I₆ in the ommatidium image defect determination part 231, the integrated determination part 232 carries out defect determination for the to-be-inspected object in a comprehensive manner. At this time, in a case where the above-mentioned determination result “indeterminable” has been obtained, a table of a parallax data storage part 25 is used, and the integrated determination part 232 finally determines whether a defect exists in the to-be-inspected object, considering parallax between the ommatidium images. For this purpose, based on the distance between the imaging apparatus and the to-be-inspected object, the difference amounts of the imaging positions of the to-be-inspected object 1 in the respective ommatidium images are previously calculated, and the calculated difference amounts are stored in the parallax data storage part 25 in a form of the table. In the first embodiment, the table (parallax table) shown in FIG. 5 is stored in the parallax data storage part 25.

The determination result in the defect determination part 23 is sent to the output apparatus 30. The output apparatus 30 is a general term of one or more of a sound output apparatus, a display apparatus, a printer, and so forth. In a case where the output apparatus 30 is a sound output apparatus, and in a case where the determination result is “defect exists”, the sound output apparatus outputs a beep sound, for example.

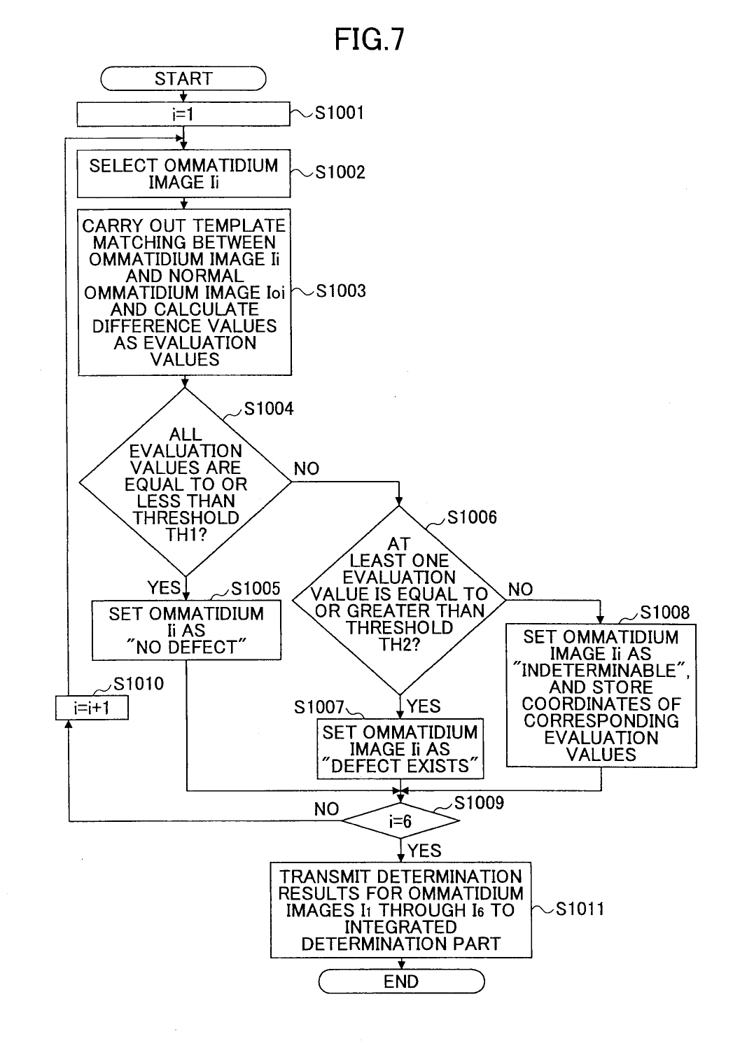

First, processing of the ommatidium defect determination part 231 in the first embodiment will be described. FIG. 7 shows a processing flowchart of the ommatidium defect determination part 231 in the first embodiment. In the flowchart, “i” denotes the numbers of ommatidium images I₁ through I₆.

First, i=1 is set (step S1001), and the first ommatidium image I₁ is selected from the 6 ommatidium images I₁ through I₆ (step S1002). Then, for the ommatidium image I₁, it is determined whether the determination result is “no defect”, “defect exists” or “indeterminable”, as follows. That is, the normal ommatidium image Iₙ corresponding to the ommatidium image I₁ is read from the normal data storage part 24, template matching is carried out between the ommatidium image I₁ and the normal ommatidium image I₀₁, and an evaluation value is obtained (step S1003). A size of the template is selected appropriately. For example, a template of a size of a pixel may be prepared, or a template of a larger size of m×m pixels (a small area) may be prepared. In the case of a template of a size of a pixel, the absolute values of differences in the respective pixel values between the ommatidium image I₁ and the normal ommatidium image Iₙ are obtained as the evaluation values. In the case of a template of a size of m×m pixels (a small area), the total or the sum of squares of differences in the respective pixel values in each small area between the ommatidium image I₁ and the normal ommatidium image I₀₁ is obtained as the evaluation value. Thus, template matching is carried out for each pixel or for each small area between the ommatidium image I₁ and the normal ommatidium image I₀₁, and when all of the evaluation values are equal to or less than a threshold TH1, the ommatidium image I₁ is set as “no defect” (steps S1004, S1005). In a case where at least one of the evaluation values is greater than the threshold TH1, it is determined whether at least one of the evaluation values each greater than the threshold TH1 is equal to or greater than a threshold TH2 (step S1006). It is noted that TH 1<TH2. When at least one of the evaluation values each greater than the threshold TH1 is equal to or greater than the threshold TH2, the ommatidium image I₁ is set as “defect exists” (step S1007). In the other cases, the ommatidium image I₁ is set as “indeterminable”, and the coordinate values of all of the evaluation values each greater than the threshold TH1 and less than the threshold value TH2 are stored (step S1008). In the case of using the template of the size of a pixel, the coordinate values are the coordinate values of the corresponding pixels. In the case of using the template of the size of a small area, the coordinate values are, for example, the coordinate values at the four corners of the corresponding small areas.

Thus, the ommatidium image I₁ and the normal ommatidium image I₀₁ are compared for each pixel or for each small area, and the evaluation values are obtained. Then, as the thresholds, TH1 and TH2 (greater than TH1) are used. Then, when all of the evaluation values are equal to or less than TH1, the ommatidium image I₁ is set as “no defect”. When at least one of the evaluation values is greater than TH2, the ommatidium image I₁ is set as “defect exists”. In other cases (at least one of the evaluation values is greater than TH1 and all of the corresponding evaluation values are less than TH2), the ommatidium image I₁ is set as “indeterminable”. In the case of “indeterminable”, the coordinate values of the corresponding evaluation values (each of which is greater than TH1 and less than TH2) are stored. Hereinafter, the pixels or the small areas, determined as “indeterminable” (each of the evaluation values of which is greater than TH1 and less than TH2), in the ommatidium image, will be referred to as “provisional defect positions”.

After that, it is determined whether “i” becomes 6 (step S1009). In a case where “i” is less than 6, “i+1” is set in “i” (step S1010), and the processing returns to step S1002. Thereafter, the processing of steps S1002 through S1008 is repeated until “i” becomes 6. That is, the same as for the above-mentioned ommatidium image I_{I}, it is determined, for the ommatidium images I₂ through I₆, whether each of the determination results is “no defect”, “defect exists” or “indeterminable”. Then, the determination results for the ommatidium images I₁ through I₆ are sent to the integrated determination part 232 (step S1011).

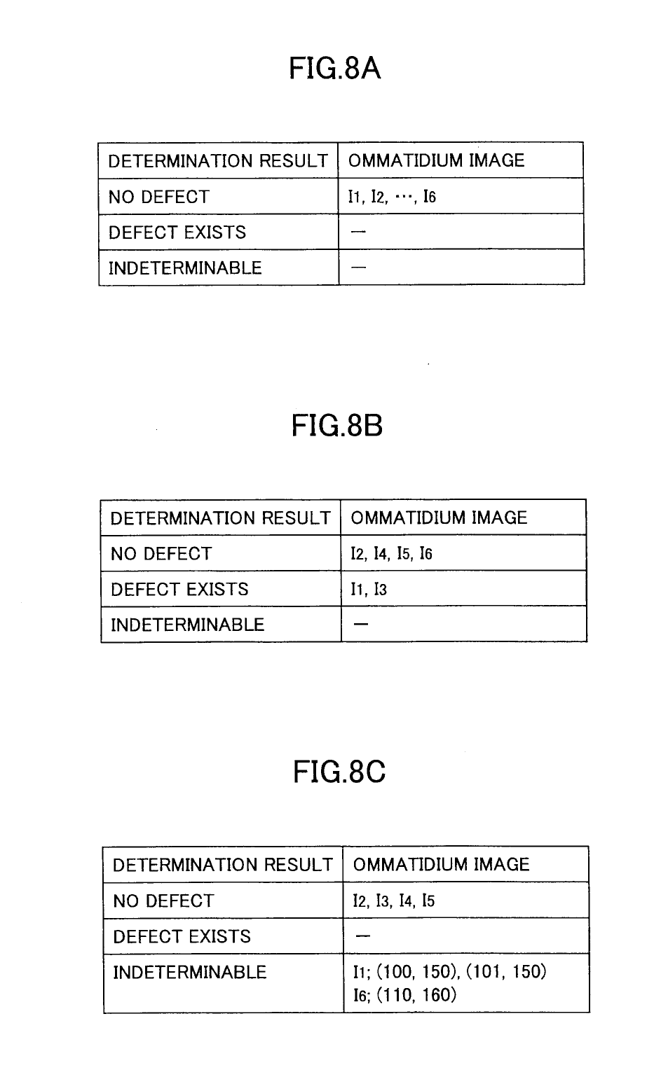

FIGS. 8A, 8B and 8C show examples of the determination results in the ommatidium image defect determination part 231. FIG. 8A shows an example of the to-be-inspected object 1 (workpiece) for which all of the ommatidium images I₁ through I₆ are determined as “no defect”. FIG. 8B shows an example of the to-be-inspected object 1 (workpiece) for which the ommatidium images I₁ and I₃ are determined as “defect exists” and the remaining ommatidium images I₂, I₄, I₅ and I₆ are determined as “no defect”. FIG. 8C shows an example of the to-be-inspected object 1 (workpiece) for which none of the ommatidium images I₁ through I₆ are determined as “defect exists”, the ommatidium images I₂, I₃, I₄ and I₅ are determined as “no defect”, and the ommatidium image I₁ and I₆ are determined as “indeterminable”. As shown in FIG. 8C, the ommatidium image I₁ is determined as “indeterminable” at the coordinate sets (100, 150) and (101, 150), and the ommatidium image I₆ is determined as “indeterminable” at the coordinate set (110, 160). That is, in the ommatidium image I₁, the coordinate sets (100, 150) and (101, 150) correspond to the provisional defect positions, and in the ommatidium image I₆, the coordinate set (110, 160) corresponds to the provisional defect position. This is an example for a case where the template of the size of a pixel is used. In a case of using the template of the size of m×m pixels, the coordinate sets at the four corners of each small area, for example, determined as “indeterminable” (each of the evaluation values of which is greater than TH1 and less than TH2), are stored. That is, these small areas correspond to the provisional defect positions. It is noted that in FIGS. 8A, 8B and 8C, it is also possible that for “no defect” and “defect exists”, instead of the respective numbers (I₁ through I₆) of the corresponding ommatidium images, the number (quantity) of the corresponding ommatidium images (the number of the determination results “no defect” and the number of the determination results “defect exists”) may be set. For example, in the case of FIG. BB, setting may be carried out in such a manner that the number of the determination results “no defect” is “4” and the number of the determination results “defect exists” is “2”.

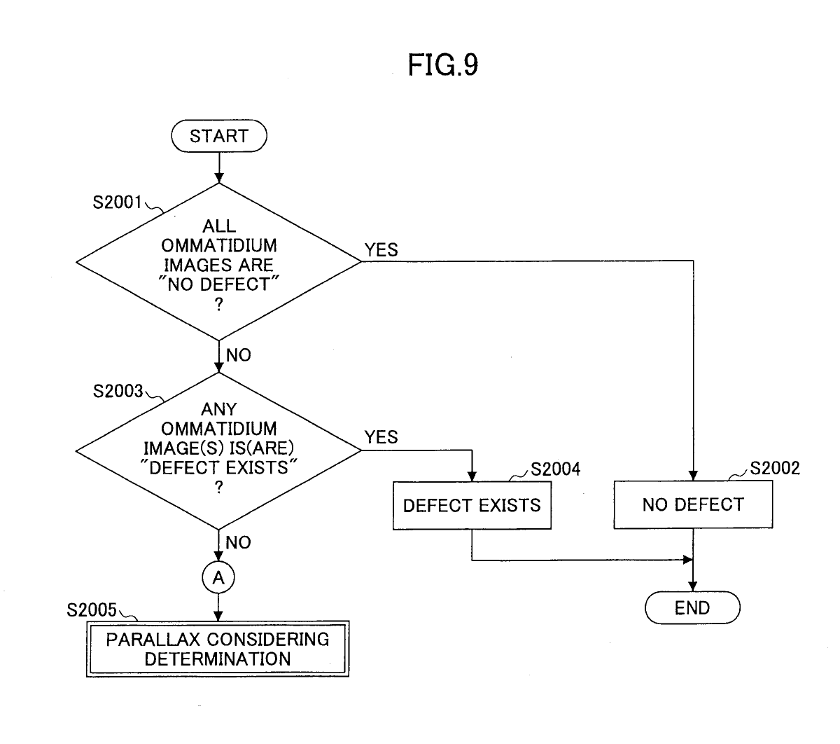

Next, details of processing of the integrated determination part 232 will be described. FIG. 9 shows an overall processing flowchart of the integrated determination part 232 according to the first embodiment. First, as to the determination results of the ommatidium image defect determination part 231, it is determined whether each of all of the ommatidium images I₁ through I₆ has the determination result “no defect” (step S2001). When each of all of the ommatidium images I₁ through I₆ has the determination result “no defect”, the to-be-inspected object 1 is determined as “no defect” (step S2002), and the processing is finished. FIG. BA corresponds to this case. In a case where not all of the ommatidium images I₁ through I₆ have been determined as “no defect”, it is determined (in step S2003) whether at least one of the ommatidium images I₁ through I₆ has the determination result “defect exists”. When at least one of the ommatidium images I₁ through I₆ has the determination result “defect exists”, the to-be-inspected object 1 is determined as “defect exists” (step S2004), and the processing is finished. FIG. 8B corresponds to this case. On the other hand, when it has been determined that there is no ommatidium image of “defect exists” in step S2003, the processing proceeds to parallax considering determination (step S2005). That is, for example, in a case where the number of the ommatidium images of “no defect” is 5 or less and also, the number of the ommatidium images of “defect exists” is 0, all of the ommatidium images other than the ommatidium images of “no defect” are the ommatidium images of “indeterminable”. In the parallax considering determination, attention is paid to the ommatidium images of “indeterminable”, and it is finally determined whether the to-be-inspected object 1 (workpiece) has a defect. FIG. 8C corresponds to this case. According to the first embodiment, as to the provisional defect positions (the coordinate sets or the small areas for which the determination of “indeterminable” has been made (each of the evaluation values is greater than TH1 and less than TH2)), parallax correction is carried out using the parallax table of the parallax data storage part 25, and after that, the provisional defect positions are compared between the ommatidium images of “indeterminable”. Then, when the provisional defect positions coincide with one another between the ommatidium images of “indeterminable”, the to-be-inspected object is determined as “defect exists”. When the provisional defect positions do not coincide with one another between the ommatidium images of “indeterminable”, the to-be-inspected object is determined as “no defect”. This processing is carried out for all of the combinations of the ommatidium images of “indeterminable”. During the processing, when the determination result “defect exists” (i.e., the provisional defect positions coincide with one another between the ommatidium images of “indeterminable”) is obtained, the processing is terminated at this point of time. It is noted that in a case where the number of the ommatidium images of “indeterminable” is only one, the to-be-inspected object is determined as “no defect”.

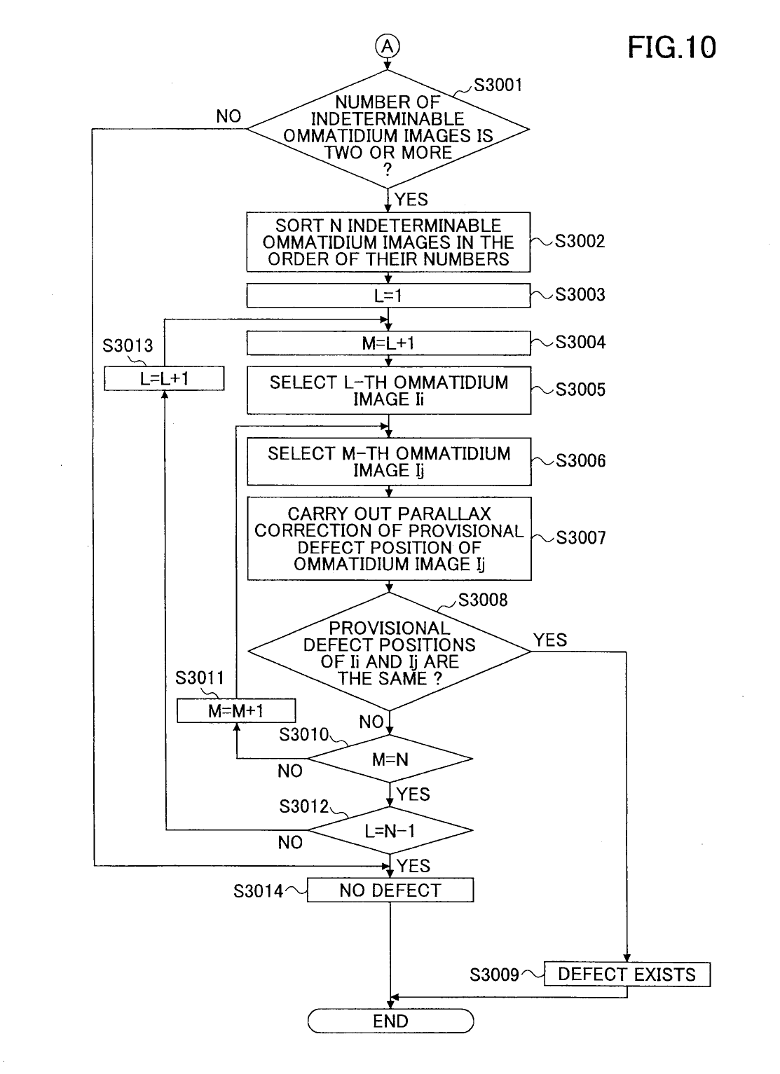

FIG. 10 shows a detailed processing flowchart of the parallax considering determination (step S2005 in FIG. 9) according to the first embodiment. Here, the template matching using the template of the size of a pixel is assumed. That is, in this case, as shown in FIG. 8C, each of the provisional defect positions of the ommatidium images of “indeterminable” is indicated by one set of coordinate values. Further, it is assumed that the parallax table of the parallax data storage part 25 is that of FIG. 5.

First, it is determined whether the number of the ommatidium images of “indeterminable” is 2 or more (step S3001). When the number of the ommatidium images of “indeterminable” is only one, the to-be-inspected object is determined as “no defect” (step S3014), and the processing is finished. That is, the provisional defect position in the corresponding ommatidium image is regarded as noise.

In a case where the number of the ommatidium images of “indeterminable” is 2 or more (referred to as N, hereinafter), the ommatidium images of “indeterminable” are sorted in the ascending order (step S3002). Then, L=1 and M=L+1 (=2) are set as an initial setting (steps S3003, S3004). Here, L and M denote sort numbers (1 through N). Next, the L-th ommatidium image Ii and the M-th ommatidium image Ij are selected from the thus sorted N ommatidium images of “indeterminable” (steps S3005, S3006). Here, “i” and “j” denote the actual numbers (1 through 6) of the ommatidium images of “indeterminable”. Specifically, “i” denotes the numbers of the ommatidium images in the vertical direction in FIG. 5, and “j” denotes the numbers of the ommatidium images in the horizontal direction in FIG. 5.

Next, the parallax table (FIG. 5) of the parallax data storage part 25 is used, for the coordinate set of each of the provisional defect positions in the M-th ommatidium image Ij, correction is carried out for the difference amount (parallax amount) from the coordinate set of the L-th ommatidium image Ii (step S3007). That is, the viewpoint of the ommatidium image Ij is corrected to the viewpoint of the ommatidium image Ii (parallax correction). For example, in a case where the ommatidium image Ii is I₁, and the ommatidium image Ij is I₂, the coordinate set (Xj, Yj) of the provisional defect position in the ommatidium image Ij is corrected as Xj′=Xj−F/D*dx, and Yj′=Yj, according to FIG. 5. Such processing is carried out on the coordinate sets of all of the provisional defect positions of the ommatidium image Ij.

Next, the coordinate sets of all of the provisional defect positions in the L-th ommatidium image Ii are compared with the coordinate sets (after the parallax correction) of all of the provisional defect positions in the M-th ommatidium image Ij, and it is determined whether the same provisional defect positions exist (step S3008). When there are at least two provisional defect positions that are the same between the ommatidium images Ii and Ij, it is determined that the to-be-inspected object has a defect (“defect exists”) (step S3009), and the processing is finished.

For example, in the case of FIG. 8C, the ommatidium images I₁ and I₆ are selected in steps S3005 and S3006. Then, for the purpose of convenience for explanation, it is assumed that, as a result of the parallax correction being carried out on the coordinate set (110, 160) at the provisional defect position in the ommatidium image I₆ in step S3007, the coordinate set (100, 150) is obtained. Then, in step S3008, the coordinate sets (100, 150), (101, 150) at the provisional defect positions in the ommatidium image I₁ are compared with the coordinate set (100, 150) (after the parallax correction) at the provisional defect position in the ommatidium image I₆. As a result, since the coordinate set (100, 150) is the same between the ommatidium images I₁ and I₆, the to-be-inspected object 1 (workpiece) is finally determined as “defect exists”.

Returning to FIG. 10, in a case where there are no provisional defect positions that are the same between the L-th and M-th ommatidium images Ii and Ij, it is determined whether M has reached N (step S3010). In a case where M has not yet reached N, M is incremented by 1 (step S3011), and the processing returns to step S3006. When M has reached N, it is determined whether L has reached N-1 (step S3012). In a case where L has not yet reached N-1, L is incremented by 1 (step S3013), and the processing returns to step S3004. After that, the processing is repeated, and when L has reached N-1, it is determined that the to-be-inspected object 1 has no defect (“no defect”) (step S3014). That is, in a case where there are no provisional defect positions that are the same between the N ommatidium images of “indeterminable”, the provisional defect positions are regarded as noise, and the to-be-inspected object 1 is determined as “no defect”.

It is noted that actually, even when the parallax correction is carried out, it may be difficult to obtain the configuration for causing the coordinate sets to coincide with each other between the ommatidium images for each pixel, because of an actual condition of assembling the camera or the like. Therefore, it is preferable that to determine that the provisional defect positions are the same between the ommatidium images of “indeterminable”, when the provisional defect positions coincide, within an allowable range that is appropriately set previously, with each other between the ommatidium images of “indeterminable”. Further, in a case of carrying out template matching using the template of the size of m×m pixels, the determination as to whether the provisional defect positions are the same between the ommatidium images of “indeterminable” is carried out through comparison between the small areas. Also in this case, it may be determined that the provisional defect positions (areas) are the same between the ommatidium images of “indeterminable”, when the small areas coincide, within an allowable range that is appropriately set previously, with each other between the ommatidium images of “indeterminable”.

### Second Embodiment

As shown in FIG. 1, in the imaging apparatus, the lens array having a simple structure of arranging the plural lenses on both or one of the to-be-inspected object side and the image side is used. In a case of imaging the to-be-inspected object 1 (workpiece) using the imaging apparatus, the degree of out-of-focus becomes larger as the position shifts to the periphery from the center in each ommatidium image. This is the same also for a case of imaging a normal workpiece. Therefore, in a case where the ommatidium image is compared with the normal ommatidium image for each pixel or for each small area, and the absolute value of difference is obtained as the evaluation value, the evaluation value is larger in a case where a defect exists near the center of the image, and therefore, it is possible to positively determine, for the defective object, as “defect exists”. However, in a case where a defect exists in the periphery of the image, the evaluation value is smaller (because the out-of-focus image parts are compared with one another), and therefore, there may be a case where it is not possible to determine, for the defective object, as “defect exists”.

The second embodiment of the present invention has been devised in consideration of this point. More specifically, as described above, in the imaging apparatus having the simple structure of arranging the plural lenses in a form of an array, the degree of out-of-focus increases as the position in an image shifts to the periphery in comparison to the center of the image. Therefore, the determination accuracy may degrade as the position in the image shifts to the periphery of the image. In consideration of this point, improvement in the determination accuracy in the periphery of the image is aimed for in the second embodiment of the present invention.

The overall configuration of the second embodiment of the present invention is the same as that described above for the first embodiment using FIGS. 1 and 2. Also, the defect determination part 23 in the processing apparatus 20 includes the ommatidium defect determination part 231 and the integrated determination part 232 as shown in FIG. 6. However, the processing is somewhat different from that of the first embodiment described above. Below, the processing of the ommatidium defect determination part 231 and the integrated determination part 232 according to the second embodiment of the present invention will be described.

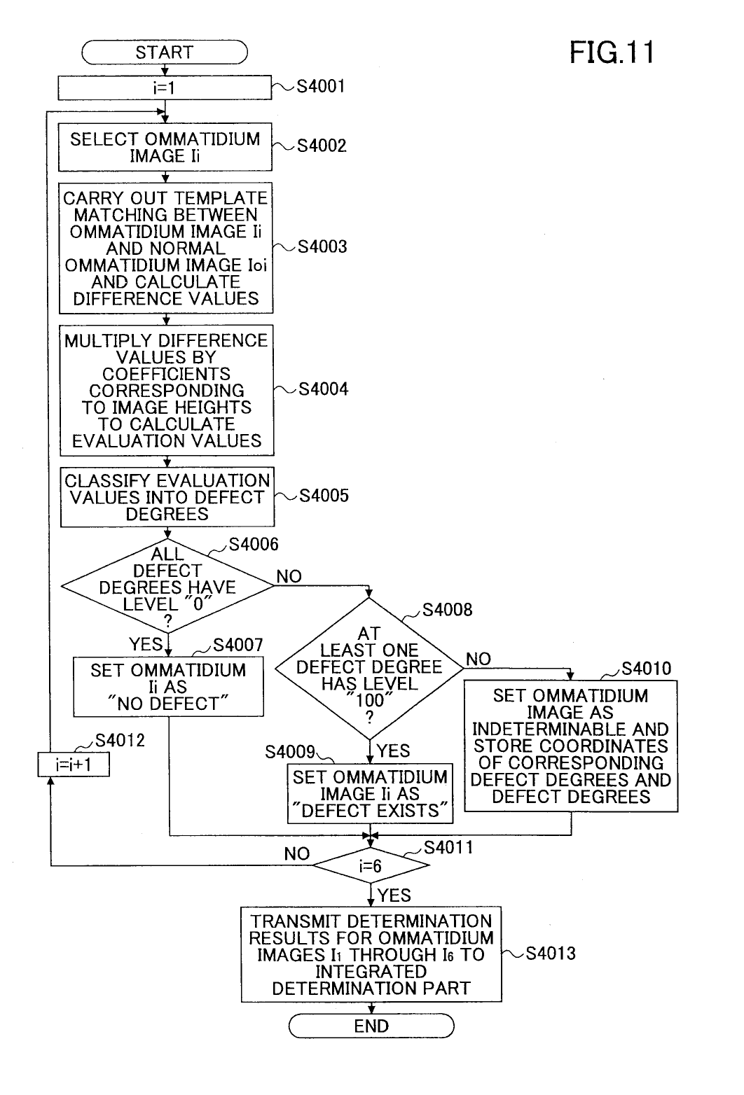

First, the processing of the ommatidium image defect determination part 231 according to the second embodiment will be described in detail. FIG. 11 shows a processing flowchart of the processing of the ommatidium image defect determination part 231 according to the second embodiment. Also here, “i” denotes the numbers of the ommatidium images I₁ through I₆.

First, i=1 is set (step S4001), and the first ommatidium image I₁ is selected from the 6 ommatidium images I₁ through I₆ (step S4002). Then, the normal ommatidium image Iₙ corresponding to the ommatidium image I₁ is read from the normal data storage part 24, template matching is carried out between the ommatidium image I₁ and the normal ommatidium image Iₙ, and the difference value is obtained (step S4003). Also in the second embodiment, a size of the template is selected appropriately. For example, a template of a size of a pixel may be prepared, or a template of a larger size of m×m pixels (a small area) may be prepared. In the case of a template of a size of a pixel, the absolute values of differences in the respective pixel values between the ommatidium image I₁ and the normal ommatidium image I₀₁ are obtained as the evaluation values. In the case of a template of a size of m×m pixels (a small area), the total or the sum of squares of differences in the respective pixel values in each small area between the ommatidium image I₁ and the normal ommatidium image Iₙ is obtained as the evaluation value. Thus, the difference value is obtained for each pixel or for each small area between the ommatidium image I. and the normal ommatidium image Iₙ.

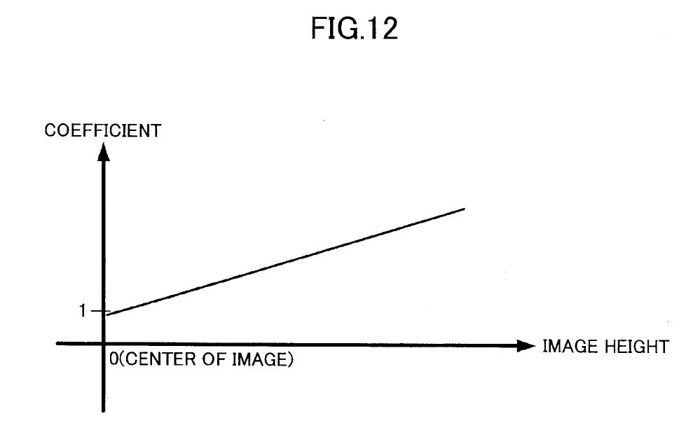

Next, an evaluation value is obtained as a result of the difference value being corrected according to the image height of the corresponding pixel or small area (step S4004). More specifically, coefficients as shown in FIG. 12 are predetermined according to the image height positions in the image (ommatidium image), the difference value at each pixel or small area in the ommatidium image I₁ is multiplied by the coefficient corresponding to the image height position of the difference value, and the evaluation value is obtained. That is, the difference value is caused to be apparently increased as the position shifts to the periphery in comparison to the center in the image. Thereby, it is possible to correct a situation of existence of a flaw or the like being less evaluated in the periphery of the image than the actual state because the degree of out-of-focus increases as the position shifts to the periphery in comparison to the center in the image.

It is noted that in FIG. 12, the coefficient is simply in direct proportion to the image height. However, actually, the coefficients may be set according to actual image out-of-focus amounts at a time of designing the lenses. Further, the coefficients corresponding to the image heights may be previously stored in a nonvolatile memory as a table (LUT) or the like. Next, the evaluation values are classified into defect degrees (step S4005). Here, as an example, the defect degrees are set in 101 levels of 0 through 100. The level 0 corresponds to “no defect” and the levels 1 through 99 correspond to “indeterminable” and the level 100 corresponds to “defect exists”. Each of the evaluation values (values obtained from multiplying the difference values with the coefficients, respectively) for the respective pixels or the respective small areas of the ommatidium image I₁ is classified into any one of the levels 0 through 100 according to the evaluation value. Ranges of the respective evaluation values corresponding to each of the levels 0 through 100 of the defect degrees are previously stored in a nonvolatile memory as a table (LUT) or the like.

After that, for the ommatidium image I₁, based on the defect degrees, it is determined whether the determination result is “no defect”, “defect exists” or “indeterminable”. That is, when all of the defect degrees for the respective pixels or the respective small areas of the ommatidium image I₁ are the level 0, the ommatidium image I₁ is set as “no defect” (steps S4006, S4007). In a case where there is the defect degree of the level 100, the ommatidium image I₁ is set as “defect exists” (steps S4008, S4009). In the other cases (i.e., each of the defect degrees other than the level 0 is any one of the levels 1 through 99), the ommatidium image I₁ is set as “indeterminable”, and the coordinate values of all of the evaluation values of the defect degrees within the levels 1 through 99 and these defect degrees are stored (step S4010). In the case using the template of the size of a pixel, the coordinate values are the coordinate values of the corresponding pixels. In the case using the template of the size of a small area, the coordinate values are, for example, the coordinate values at the four corners of each of the corresponding small areas. Hereinafter, the pixels or the small areas having the defect degrees of the levels 1 through 99 in the ommatidium image determined as “indeterminable” will be referred to as “provisional defect positions”.

After that, it is determined whether “i” becomes 6 (step S4011). In a case where “i” is less than 6, “i” is incremented by 1 (step S4012), and the processing returns to step S4002. Thereafter, the processing of steps S4002 through S4012 is repeated until “i” becomes 6. That is, the same as for the above-mentioned ommatidium image Iᵢ, it is determined, for the ommatidium images I₂ through I₆, whether each of the determination results is “no defect”, “defect exists” or “indeterminable”. Then, the determination results for the ommatidium images I_{I} through I₆ are sent to the integrated determination part 232 (step S4013).

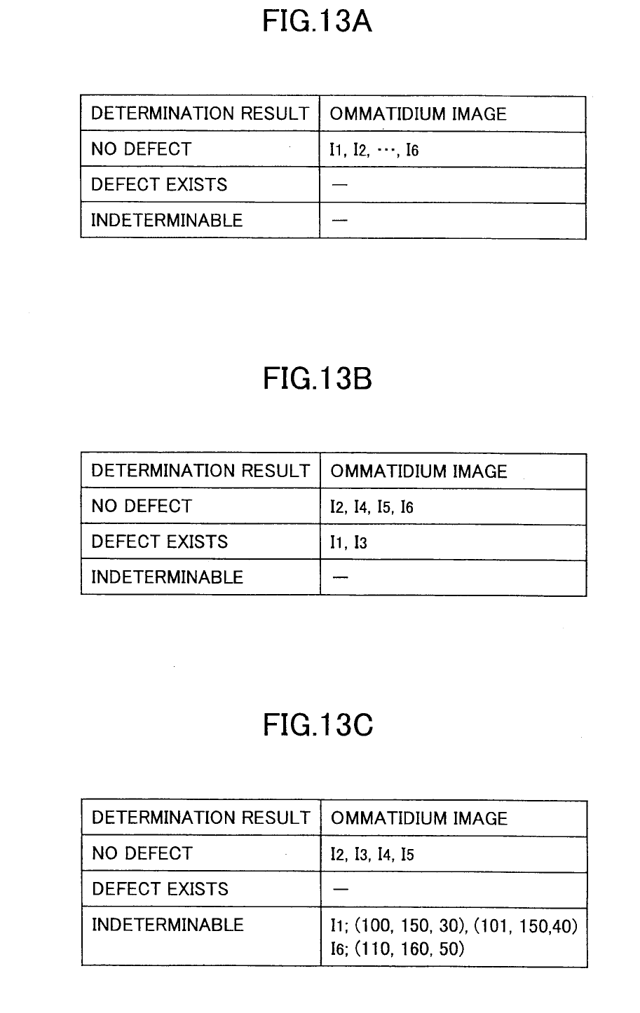

It is noted that it is also possible to determine “no defect”, “defect exists” or “indeterminable” for each of the ommatidium images in the same manner as that of the first embodiment described above using the evaluation values (the values obtained from multiplying the difference value by the coefficients, respectively). However, the reason the defect degrees are introduced, and as described above, for example, the level 0 is set as “no defect”, the level 100 is set as “defect exists”, and the levels 1 through 99 are set as “indeterminable”, is for the purpose of setting a vague zone as “indeterminable” as much as possible. Further, the reason in the case of “indeterminable”, that the defect degrees are stored together with the corresponding coordinate values, is for the purpose of using the defect degrees in parallax considering determination in the integrated determination part 232 thereafter. FIGS. 13A, 13B and 13C show examples of the determination results in the ommatidium image defect determination part 231 according to the second embodiment. FIG. 13A shows an example of the to-be-inspected object 1 (workpiece) for which all of the ommatidium images I₁ through I₆ are determined as “no defect”. FIG. 13B shows an example of the to-be-inspected object 1 (workpiece) for which the ommatidium images I₁ and I₃ are determined as “defect exists” and the remaining ommatidium images I₂, I₄, I₅ and I₆ are determined as “no defect”. FIG. 13C shows an example of the to-be-inspected object 1 (workpiece) for which none of the ommatidium images I₁ through I₆ are determined as “defect exists”, the ommatidium images I₂, I₃, I₄ and I₅ are determined as “no defect”, and the ommatidium image I₁ and I₆ are determined as “indeterminable”. As shown in FIG. 13C, the ommatidium image I₁ is determined as “indeterminable” at the coordinate sets (100, 150) and (101, 150), and the defect degrees are levels 30 and 40, respectively. The ommatidium image I₆ is determined as “indeterminable” at the coordinate set (110, 160), and the defect degree is the level 50. That is, in the ommatidium image I₁, the coordinate sets (100, 150) and (101, 150) correspond to the provisional defect positions, and in the ommatidium image I₆, the coordinate set (110, 160) corresponds to the provisional defect position. This is an example for a case where the template of the size of a pixel is used. In a case of using the template of the size of m×m pixels, the coordinate sets at the four corners of each small area, for example, which is determined as “indeterminable” (each of the defect degrees of which is in the range of 1 through 99), are stored. That is, these small areas are the provisional defect positions.

Also in the second embodiment, it is noted that in FIGS. 13A, 13B and 13C, it is also possible that for “no defect” and “defect exists”, instead of the respective numbers of the corresponding ommatidium images, the number (quantity) of the corresponding ommatidium images (the number of the determination results “no defect” and the number of the determination results “defect exists”) may be set. For example, in the case of FIG. 13B, setting is carried out, as the number of the determination results “no defect” is “4” and the number of the determination results “defect exists” is “2”.

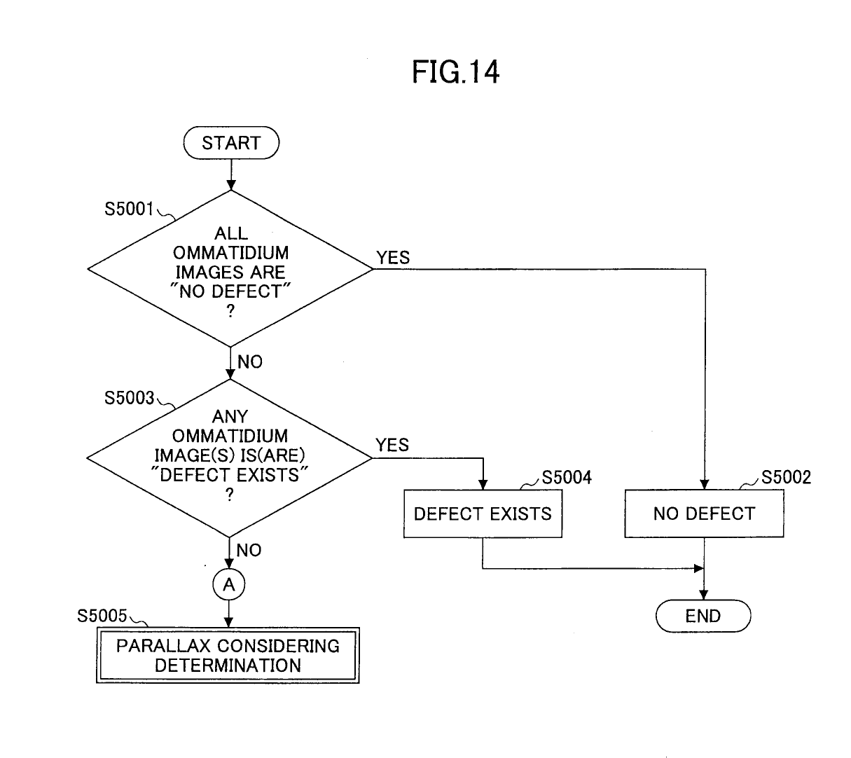

Next, details of processing of the integrated determination part 232 according to the second embodiment will be described. FIG. 14 shows an overall processing flowchart of the integrated determination part 232 according to the second embodiment. The flowchart is the same as FIG. 9. That is, as to the determination results of the ommatidium image defect determination part 231, it is determined whether all of the ommatidium images I₁ through I₆ have “no defect” (step S5001). When all of the ommatidium images I₁ through I₆ have “no defect”, the to-be-inspected object 1 is determined as “no defect” (step S5002), and the processing is finished.

FIG. 13A corresponds to this case. In a case where not all of the ommatidium images I₁ through I₆ have been determined as “no defect”, it is determined (step S5003) whether at least one of the ommatidium images I₁ through I₆ is determined to be the ommatidium image of “defect exists”. When at least one of the ommatidium images I₁ through I₆ is the ommatidium image of “defect exists”, the to-be-inspected object 1 is determined as “defect exists” (step S5004), and the processing is finished. FIG. 13B corresponds to this case.

On the other hand, when it has been determined that there is no ommatidium image of “defect exists” in step S5003, the processing proceeds to parallax considering determination (step S5005). That is, for example, in a case where the number of the ommatidium images of “no defect” is 5 or less and also, the number of the ommatidium images of “defect exists” is 0, all of the ommatidium images other than the ommatidium images of “no defect” are the ommatidium images of “indeterminable”. In the parallax considering determination, attention is paid to the ommatidium images of “indeterminable”, and it is finally determined whether the to-be-inspected object 1 (workpiece) has a defect. FIG. 13C corresponds to this case. Specifically, as to the provisional defect positions (the coordinate sets or the small areas for which the determination of “indeterminable” has been made (each of the defect degrees is within the levels 1 through 99)), parallax correction is carried out using the parallax table of the parallax data storage part 25, and after that, the provisional defect positions are compared between the ommatidium images of “indeterminable”. Then, when the provisional defect positions coincide with one another between the ommatidium images of “indeterminable”, it is determined whether the defect degrees of the corresponding provisional defect positions in both ommatidium images meet a certain condition. When the certain condition is met, the to-be-inspected object 1 is determined as “defect exists”. When the certain condition is not met, the to-be-inspected object 1 is determined as “no defect”. Further, when the provisional defect positions do not coincide with one another between the ommatidium images of “indeterminable”, also the to-be-inspected object is determined as “no defect”. This processing is carried out for all of the combinations of the ommatidium images of “indeterminable”. During the processing, when “defect exists” (i.e., the provisional defect position coincides with one another between the ommatidium images of “indeterminable” and the defect degrees at the provisional defect position of both ommatidium images meet the certain condition) is obtained, the processing is terminated at this point of time. It is noted that in a case where the number of the ommatidium images of “indeterminable” is only one, the to-be-inspected object is determined as “no defect”.

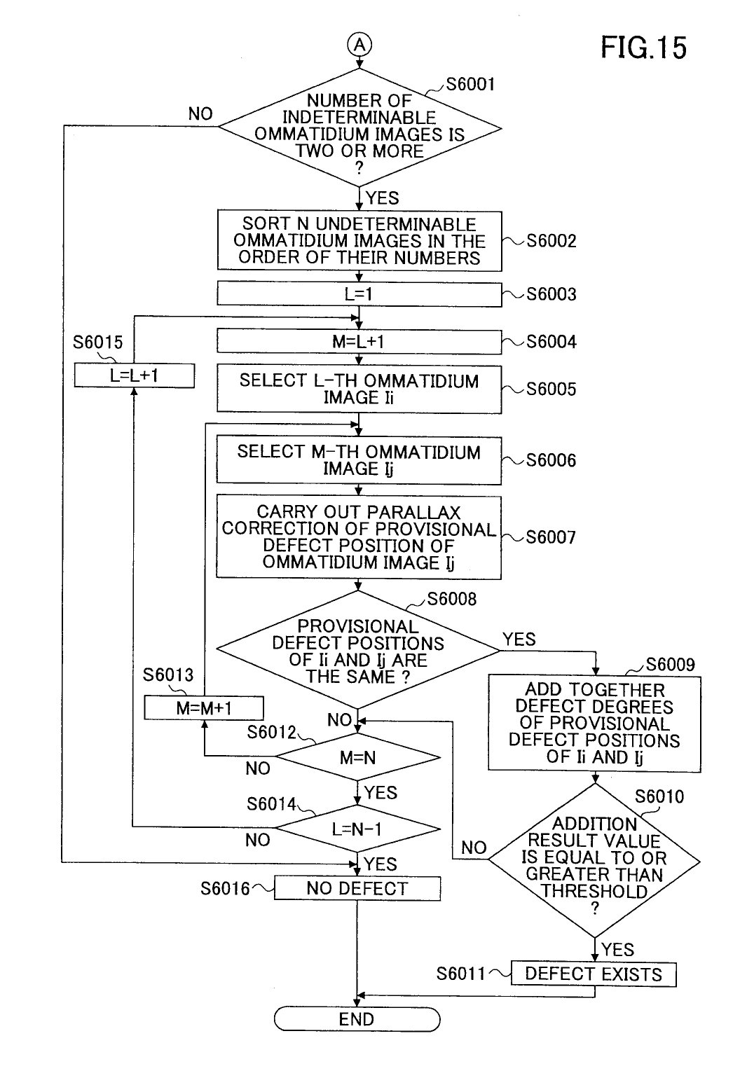

FIG. 15 shows a detailed processing flowchart of the parallax considering determination (step S5005 in FIG. 14) according to the second embodiment. Also here, the template matching using the template of the size of a pixel is assumed. That is, in this case, as shown in FIG. 13C, each of the provisional defect positions of the ommatidium images of “indeterminable” is indicated by one set of coordinate values. Further, it is assumed that the parallax table of the parallax data storage part 25 is that of FIG. 5.

In FIG. 15, steps S6009 and S6010 are different from FIG. 10 described above, and the others are the same as FIG. 10.

First, it is determined whether the number of the ommatidium images of “indeterminable” is 2 or more (step S6001). When the number of the ommatidium images of “indeterminable” is only one, the to-be-inspected object is determined as “no defect” (step S6016), and the processing is finished. That is, the provisional defect position in the corresponding ommatidium image is regarded as noise.

In a case where the number of the ommatidium images of “indeterminable” is 2 or more (referred to as N, hereinafter), the corresponding ommatidium images of “indeterminable” are sorted in the ascending order (step S6002). Then, L=1 and M=L+1 (=2) are set as an initial setting (steps S6003, S6004). Here, L and M denote sort numbers (1 through N). Next, the L-th ommatidium image Ii and M-th ommatidium image Ij are selected from the thus sorted N ommatidium images of “indeterminable” (steps S6005, S6006). Here, “i” and “j” denote the actual numbers (1 through 6) of the ommatidium images of “indeterminable”. Specifically, “i” denotes the numbers of the ommatidium images in the vertical direction in FIG. 5, and “j” denotes the numbers of the ommatidium images in the horizontal direction in FIG. 5.

Next, the parallax table (FIG. 5) of the parallax data storage part 25 is used for the coordinate set of each of the provisional defect positions in the M-th ommatidium image Ij, and correction is carried out for the difference amount (parallax amount) from the corresponding coordinate set of the L-th ommatidium image Ii (step S6007). That is, the viewpoint of the ommatidium image Ij is corrected to the viewpoint of the ommatidium image Ii (parallax correction). For example, in a case where the ommatidium image Ii is I₁, and the ommatidium image Ij is I₂, the coordinate set (Xj, Yj) of the provisional defect position in the ommatidium image Ij is corrected as Xj′=Xj−F/D*dx, and Yj′=Yj, according to FIG. 5. Such processing is carried out on the coordinate sets of all of the provisional defect positions of the ommatidium image Ij.

Next, the coordinate sets of all of the provisional defect positions in the L-th ommatidium image Ii are compared with the coordinate sets (after the parallax correction) of all of the provisional defect positions in the M-th ommatidium image Ij, and it is determined whether the same provisional defect positions exist (step S6008). When there are at least two provisional defect positions that are the same between the ommatidium images Ii and Ij, the defect degrees of the corresponding two provisional defect positions in both ommatidium images are added together, for each two corresponding provisional defect positions which are the same between the ommatidium images Ii and Ij (step S6009). Then, it is determined in step S6010 whether there is the addition result value equal to or greater than a certain threshold. When the addition result value is equal to or greater than the certain threshold, it is determined that the to-be-inspected object has a defect (“defect exists”) (step S6011), and the processing is finished. It is noted that as the certain threshold, according to the second embodiment, since the defect degrees are evaluated as 0 through 100, it is preferable to set the certain threshold at 100.

For example, in the case of FIG. 13C, the ommatidium images I₁ and I₆ are selected in steps S6005 and S6006. Then, for the purpose of convenience for explanation, it is assumed that, as a result of the parallax correction being carried out on the coordinate set (110, 160) at the provisional defect position in the ommatidium image I₆ in step S6007, the coordinate set (100, 150) is obtained. Then, in step S6008, the coordinate sets (100, 150), (101, 150) at the provisional defect positions in the ommatidium image I₁ are compared with the coordinate set (100, 150) (after the parallax correction) at the provisional defect position in the ommatidium image I₆. As a result, it is determined that the coordinate set (100, 150) is the same between the ommatidium images I_{I} and I₆. According to FIG. 13C, the defect degree of the corresponding provisional defect position in the ommatidium image I₁ is 30, and the defect degree of the corresponding provisional defect position in the ommatidium image I₆ is 50. The addition result value of both is 30+50=80. That is, even when the defect degrees of both are added together, the addition result value is still less than the certain threshold 100, and therefore, it is better not to determine the to-be-inspected object as “defect exists” in this case.

Returning to FIG. 15, in a case where there are no provisional defect positions that are the same between the L-th and M-th ommatidium images Ii and Ij (step S6008 NO), or the addition result value of the defect degrees of both provisional defect positions, if any, which are the same between the ommatidium images Ii and Ij, is less than the certain threshold (for example, 100), for each two corresponding provisional defect positions, if any, which are the same between the ommatidium images Ii and Ij (step S6008 YES→>step S6009→step S6010 NO), it is determined whether M has reached N (step S6012). In a case where M has not yet reached N, M is incremented by 1 is carried out (step S6013), and the processing returns to step S6006. When M has reached N, it is determined whether L has reached N-1 (step S6014). In a case where L has not yet reached N-1, L is incremented by 1 is carried out (step S6015), and the processing returns to step S6004. After that, the processing is repeated, and when L has reached N-1, it is determined that the to-be-inspected object has no defect (“no defect”) (step S6016). That is, in a case where there are no provisional defect positions that are the same between the N ommatidium images of “indeterminable”, the provisional defect positions are regarded as noises, and the to-be-inspected object is determined as “no defect”. Also, even in a case where there are two provisional defect positions which are the same between the N ommatidium images of “indeterminable”, the provisional defect positions are regarded as noise in a case where the addition result of the defect degrees of the two provisional defect positions that are the same between the N ommatidium images of “indeterminable” is less than the certain threshold (for example, 100). Then, the to-be-inspected object is determined as “no defect”, when the addition result of any two provisional defect positions that are the same between the N ommatidium images of “indeterminable” is less than the certain threshold (for example, 100).

As described above, actually, even when the parallax correction is carried out, it may be difficult to obtain the configuration for causing the coordinate sets to coincide with each other between the ommatidium images for each pixel, because of an actual condition of assembling the camera or the like. Therefore, it is preferable to determine that the provisional defect positions are the same between the ommatidium images of “indeterminable”, when the provisional defect positions coincide, within an allowable range that is appropriately set previously, with each other between the ommatidium images of “indeterminable”. Further, in a case of template matching using the template of the size of m×m pixels, the determination as to whether the provisional defect positions are the same between the ommatidium images of “indeterminable” is carried out through comparison between the small areas. Also in this case, it may be determined that the provisional defect positions (areas) are the same between the ommatidium images of “indeterminable”, when the small areas coincide, within an allowable range that is appropriately set previously, with each other between the ommatidium images of “indeterminable”.

The present invention is not limited to the specifically disclosed embodiments, and variations and modifications may be made without departing from the scope of the present invention.

The present application is based on Japanese Priority Application No. 2011-032219, filed Feb. 17, 2011 and Japanese Priority Application No. 2011-240980, filed Nov. 2, 2011, the entire contents of which are hereby incorporated herein by reference.

What is claimed is:

1. A defect inspection apparatus comprising:
an imaging apparatus configured to include a lens array configured to include plural lenses arranged in a form of an array, and an imaging device configured to image a compound-eye image that is a collection of ommatidium images of an object, which ommatidium images are approximately formed by the respective plural lenses of the lens array; and
a processing apparatus configured to process the compound-eye image obtained from photographing the object by the imaging apparatus, and determine whether there is a defect of the object.

2. The defect inspection apparatus as claimed in claim 1, wherein
The processing apparatus is configured to include an image capture part configured to separate the compound-eye image obtained from the imaging apparatus into the plural of the ommatidium images, and a defect determination part configured to determine whether there is the defect of the object based on the plural ommatidium images.

3. The defect inspection apparatus as claimed in claim 2, wherein
the processing apparatus is configured to further include an image correction part configured to carry out distortion correction on the respective plural ommatidium images, and
the defect determination part is configured to determine whether there is the defect of the object based on the plural ommatidium images on which the distortion correction has been carried out.

4. The defect inspection apparatus as claimed in claim 2, wherein
the defect determination part is configured to include an ommatidium image defect determination part configured to carry out defect determination on each of the plural ommatidium images, and an integrated determination part configured to determine whether there is the defect of the object based on respective determination results of the plural ommatidium images obtained from the ommatidium image defect determination part.

5. The defect inspection apparatus as claimed in claim 4, wherein
the ommatidium image defect determination part is configured to determine no defect, defect exists or indeterminable for each of the plural ommatidium images and
the integrated determination part is configured to determine that the object has no defect in a case where all of the plural ommatidium images are determined to have no defect, determine that the object has a defect in a case where at least one of the plural ommatidium images is determined to have the defect, and determine, in the other cases, whether the object has the defect based on the indeterminable ommatidium images.

6. The defect inspection apparatus as claimed in claim 5, wherein
the ommatidium image defect determination part is configured to obtain a difference value, as an evaluation value, for each pixel or each small area between each of the plural ommatidium images and a normal ommatidium image, and determine the ommatidium image as having no defect in a case where the evaluation values of all of the respective pixels or the respective small areas are equal to or less than a first threshold, determine the ommatidium image as having the defect in a case where at least one evaluation value is equal to or greater than a second threshold that is greater than the first threshold, and determine the ommatidium image as indeterminable in the other cases; and
the integrated determination part is configured to determine that the object has no defect in a case where all of the plural ommatidium images are determined as having no defect, determine that the object has the defect in a case where at least one of the plural ommatidium images is determined as having the defect, and in the other cases, based on the indeterminable ommatidium images, determine that the object has no defect in a case where the number of the indeterminable ommatidium images is one, determine, in a case where the number of the indeterminable ommatidium images is two or more, that the object has the defect when pixels or small areas having the evaluation values greater than the first threshold and less than the second threshold exist at the same positions between the respective indeterminable ommatidium images on which parallax correction has been carried out, and determine that the object has no defect when pixels or small areas having the evaluation values greater than the first threshold and less than the second threshold do not exist at the same positions between the respective indeterminable ommatidium images on which parallax correction has been carried out.

7. The defect inspection apparatus as claimed in claim 5, wherein
the ommatidium image defect determination part is configured to obtain a difference value for each pixel or each small area between each of the plural ommatidium images and a normal ommatidium image, obtain an evaluation value that has been corrected according to an image height of the pixel or small area, classify each of the evaluation values into a defect degree of any one of predetermined plural levels, and determine the ommatidium image as having no defect in a case where the defect degrees of all of the respective pixels or the respective small areas have the minimum one of the predetermined plural levels, determine the ommatidium image to have the defect in a case where at least one defect degree has the maximum one of the predetermined plural levels, and determine the ommatidium image as indeterminable in the other cases; and
the integrated determination part is configured to determine that the object has no defect in a case where all of the plural ommatidium images are determined to have no defect, determine that the object has the defect in a case where at least one of the plural ommatidium images is determined to have the defect, and in the other cases, based on the indeterminable ommatidium images, determine that the object has no defect in a case where the number of the indeterminable ommatidium images is one, determine, in a case where the number of the indeterminable ommatidium images is two or more, that the object has the defect in a case where pixels or small areas having the defect degrees greater than the minimum one and less than the maximum one of the predetermined plural levels exist at the same positions between the respective indeterminable ommatidium images on which parallax correction has been carried out, and also, an addition result of the corresponding defect degrees is equal to or greater than the maximum one of the predetermined plural levels, and determine that the object has no defect in a case where pixels or small areas having the defect degrees greater than the minimum one and less than the maximum one of the predetermined plural levels do not exist at the same positions between the respective indeterminable ommatidium images on which parallax correction has been carried out, or an addition result of the corresponding defect degrees is less than the maximum one of the predetermined plural levels even when pixels or small areas having the defect degrees greater than the minimum one and less than the maximum one of the predetermined plural levels exist at the same positions between the respective indeterminable ommatidium images on which parallax correction has been carried out.

8. The defect inspection apparatus as claimed in claim 1, further comprising an illuminant that illuminates the object.

9. A defect inspection method of using an imaging apparatus configured to include a lens array configured to include plural lenses arranged in a form of an array, and an imaging device configured to image a compound-eye image that is a collection of ommatidium images of an object approximately formed by the respective plural lenses of the lens array, and processing the compound-eye image obtained from imaging photographing the object to determine whether there is a defect of the object, the defect inspection method comprising:
separating the compound-eye image obtained from the imaging apparatus into the plural of the ommatidium images; and
determining whether there is the defect of the object based on the plural ommatidium images.

10. The defect inspection method as claimed in claim 9, further comprising:
carrying out distortion correction on the plural ommatidium images, respectively; and
determining whether there is the defect of the object based on the plural ommatidium images on which the distortion correction has been carried out.

11. The defect inspection method as claimed in claim 9, wherein
the determining whether there is the defect of the object includes carrying out defect determination on each of the plural ommatidium images, and determining whether there is the defect of the object based on respective determination results of the plural ommatidium images obtained from the defect determination on each of the plural ommatidium images.

12. The defect inspection method as claimed in claim 11, wherein
the defect determination on each of the plural ommatidium images includes determining no defect, defect exists or indeterminable for each of the plural ommatidium images, and
the determining whether there is the defect of the object includes determining that the object has no defect in a case where all of the plural ommatidium images are determined as having no defect, determining that the object has the defect in a case where at least one of the plural ommatidium images is determined to have the defect, and determining, in the other cases, whether there is the defect of the object based on the indeterminable ommatidium images.

13. The defect inspection method as claimed in claim 12, wherein
the defect determination on each of the plural ommatidium images includes obtaining a difference value, as an evaluation value, for each pixel or each small area between each of the plural ommatidium images and a normal ommatidium image, and determining the ommatidium image as having no defect in a case where the evaluation values of all of the respective pixels or the respective small areas are equal to or less than a first threshold, determining the ommatidium image as having the defect in a case where at least one evaluation value is equal to or greater than a second threshold that is greater than the first threshold, and determining the ommatidium image as indeterminable in the other cases; and
the determining whether there is the defect of the object includes determining that the object has no defect in a case where all of the plural ommatidium images are determined as having no defect, determining that the object has the defect in a case where at least one of the plural ommatidium images is determined to have the defect, and in the other cases, based on the indeterminable ommatidium images, determining that the object has no defect in a case where the number of the indeterminable ommatidium images is one, determining, in a case where the number of the indeterminable ommatidium images is two or more, that the object has the defect when pixels or small areas having the evaluation values greater than the first threshold and less than the second threshold exist at the same positions between the respective indeterminable ommatidium images on which parallax correction has been carried out, and determining that the object has no defect when pixels or small areas having the evaluation values greater than the first threshold and less than the second threshold do not exist at the same positions between the respective indeterminable ommatidium images on which parallax correction has been carried out.

14. The defect inspection method as claimed in claim 12, wherein
the defect determination on each of the plural ommatidium images includes obtaining a difference value for each pixel or each small area between each of the plural ommatidium images and a normal ommatidium image, obtaining an evaluation value that has been corrected according to an image height of the pixel or small area, classifying each of the evaluation values into a defect degree of any one of predetermined plural levels, and determining the ommatidium image as having no defect in a case where the defect degrees of all of the respective pixels or the respective small areas have the minimum one of the predetermined plural levels, determining the ommatidium image as having the defect in a case where at least one defect degree has the maximum one of the predetermined plural levels, and determining the ommatidium image as indeterminable in the other cases; and
the determining whether there is the defect of the object includes determining that the object has no defect in a case where all of the plural ommatidium images are determined as having no defect, determining that the object has the defect in a case where at least one of the plural ommatidium images is determined as having the defect, and in the other cases, based on the indeterminable ommatidium images, determining that the object has no defect in a case where the number of the indeterminable ommatidium images is one, determining, in a case where the number of the indeterminable ommatidium images is two or more, that the object has the defect in a case where pixels or small areas having the defect degrees greater than the minimum one and less than the maximum one of the predetermined plural levels exist at the same positions between the respective indeterminable ommatidium images on which parallax correction has been carried out, and also, an addition result of the corresponding defect degrees is equal to or greater than the maximum one of the predetermined plural levels, and determining that the object has no defect in a case where pixels or small areas having the defect degrees greater than the minimum one and less than the maximum one of the predetermined plural levels do not exist at the same positions between the respective indeterminable ommatidium images on which parallax correction has been carried out, or an addition result of the corresponding defect degrees is less than the maximum one of the predetermined plural levels even when pixels or small areas having the defect degrees greater than the minimum one and less than the maximum one of the predetermined plural levels exist at the same positions between the respective indeterminable ommatidium images on which parallax correction has been carried out.
